(19) United States
(12) Patent Application Publication
(10) Pub. No.: US 2024/0027673 A1
(43) Pub. Date: Jan. 25, 2024

(54) MULTIVIEW BACKLIGHT, DISPLAY, AND METHOD HAVING MULTI-AXIS ILLUMINATION

(71) Applicant: LEIA INC., Menlo Park, CA (US)

(72) Inventors: David A. Fattal, Mountain View, CA (US); Ming Ma, Menlo Park, CA (US)

(21) Appl. No.: 18/479,101

(22) Filed: Oct. 1, 2023

Related U.S. Application Data
(63) Continuation of application No. PCT/US2021/031433, filed on May 7, 2021.

(51) Int. Cl. F21V 8/00

(52) U.S. Cl. CPC G02B 6/0036; G02B 6/0068

(57) ABSTRACT

A multiview backlight includes a light guide to guide light as guided light having a first direction and a different second direction within the light guide. The multiview backlight includes a multibeam element array having a plurality of spaced apart multibeam elements that each include a plurality of scattering sub-elements configured to scatter out portions of the guided light as directional light beams corresponding to different view directions of a multiview display. A first scattering sub-element of the plurality of scattering sub-elements is configured to selectively scatter out a portion of the guided light having the first direction and a second scattering sub-element of the plurality of scattering sub-elements is configured to selectively scatter out at least a portion of the guided light having the second direction.

### CROSS-REFERENCE TO RELATED APPLICATIONS

This application is a continuation patent application of and claims priority to International Patent Application No. PCT/US2021/031433, filed May 7, 2021, the entire contents of which are incorporated by reference herein.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a perspective view of a multiview display in an example, according to an embodiment consistent with the principles described herein.

FIG. 1B illustrates a graphical representation of angular components of a light beam having a particular principal angular direction corresponding to a view direction of a multiview display in an example, according to an embodiment consistent with the principles described herein.

FIG. 2 illustrates a cross sectional view of a diffraction grating in an example, according to an embodiment consistent with the principles described herein.

FIG. 3A illustrates a cross-section view of a multiview backlight in an example, according to an embodiment consistent with the principles described herein.

FIG. 3B illustrates a plan view of a multiview backlight in an example, according to an embodiment consistent with the principles described herein.

FIG. 3C illustrates a perspective view of a multiview backlight in an example, according to an embodiment consistent with the principles described herein.

FIG. 4 illustrates a cross-sectional view of a backlight in an example, according to an embodiment consistent with the principles described herein.

FIG. 5 illustrates a top view of a backlight in an example, according to an embodiment consistent with the principles described herein.

FIG. 6A illustrates a cross-sectional view of a portion of a backlight in an example, according to an embodiment consistent with the principles described herein.

FIG. 6B illustrates a cross-sectional view of a portion of a backlight in an example, according to another embodiment consistent with the principles described herein.

FIG. 7 illustrates a method of multiview backlight operation in accordance with an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide a multiview or three-dimensional (3D) display and a multiview backlight with application to the multiview display. In particular, embodiments consistent with the principles described herein provide a multiview backlight employing an array of multibeam elements configured to provide light beams having a plurality of different principal angular directions. According to various embodiments, each of the multibeam elements comprises one or more scattering sub-elements configured to scatter light out of a light guide as directional light beams corresponding to different view directions of the multiview display. Further, according to various embodiments, the scattering sub-elements are configured to selectively scatter out at least a portion of light in the light guide, scattering selectivity depending on a propagation direction of the light in the light guide. Using light propagating in different directions within the light guide in conjunction with the scattering selectivity of the scattering sub-elements of the multibeam elements may provide increased brightness of the multiview backlight or equivalently of the multiview display that employs the multiview backlight, according to various embodiments.

In various embodiments, the multibeam elements may be sized relative to sub-pixels of a multiview pixel in a multiview display and may also be spaced apart from one another in a manner corresponding to a spacing of multiview pixels in the multiview display. Further, the different principal angular directions of the light beams provided by the multibeam elements of the multiview backlight correspond to different directions of various different views of the multiview display, according to various embodiments. Uses of multiview backlights and multiview displays described herein include, but are not limited to, mobile telephones (e.g., smart phones), watches, tablet computes, mobile computers (e.g., laptop computers), personal computers and computer monitors, automobile display consoles, camera displays, and various other mobile as well as substantially non-mobile display applications and devices.

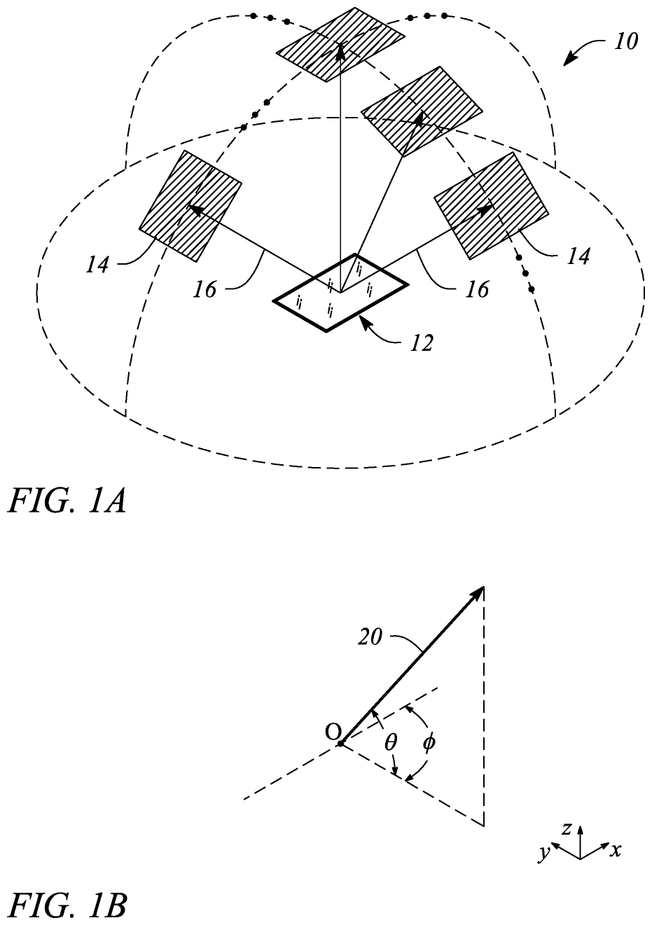

Herein, a ‘multiview display’ is defined as an electronic display or display system configured to provide different views of a multiview image in different view directions. FIG. 1A illustrates a perspective view of a multiview display 10 in an example, according to an embodiment consistent with the principles described herein. As illustrated in FIG. 1A, the multiview display 10 comprises a screen 12 to display a multiview image to be viewed. The multiview display 10 provides different views 14 of the multiview image in different view directions 16 relative to the screen 12. The view directions 16 are illustrated as arrows extending from the screen 12 in various different principal angular directions; the different views 14 are illustrated as shaded polygonal boxes at the termination of the arrows (i.e., depicting the view directions 16); and only four views 14 and four view directions 16 are illustrated, all by way of example and not limitation. Note that while the different views 14 are illustrated in FIG. 1A as being above the screen 12, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view.

A view direction or equivalently a light beam having a direction corresponding to a view direction of a multiview display generally has a principal angular direction given by angular components {θ, φ}, by definition herein. The angular component θ is referred to herein as the ‘elevation component’ or ‘elevation angle’ of the light beam. The angular component φ is referred to as the ‘azimuth component’ or ‘azimuth angle’ of the light beam. By definition, the elevation angle θ is an angle in a vertical plane (e.g., perpendicular to a plane of the multiview display screen while the azimuth angle φ is an angle in a horizontal plane (e.g., parallel to the multiview display screen plane). FIG. 1B illustrates a graphical representation of the angular components {θ, φ} of a light beam 20 having a particular principal angular direction corresponding to a view direction (e.g., one of the view directions 16 from the example of FIG. 1A) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 1B also illustrates the light beam (or view direction) point of origin O.

Further herein, the term ‘multiview’ as used in the terms ‘multiview image’ and ‘multiview display’ is defined as a plurality of views representing different perspectives or including angular disparity between views of the view plurality. In addition, herein the term ‘multiview’ explicitly includes more than two different views (i.e., a minimum of three views and generally more than three views), by definition herein. As such, ‘multiview display’ as employed herein is explicitly distinguished from a stereoscopic display that includes only two different views to represent a scene or an image. Note however, while multiview images and multiview displays include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set of sub-pixels representing ‘view’ pixels in each view of a plurality of different views of a multiview display. In particular, a multiview pixel may have an individual sub-pixel corresponding to or representing a view pixel in each of the different views of the multiview image. Moreover, the sub-pixels of the multiview pixel are so-called ‘directional pixels’ in that each of the sub-pixels is associated with a predetermined view direction of a corresponding one of the different views, by definition herein. Further, according to various examples and embodiments, the different view pixels represented by the sub-pixels of a multiview pixel may have equivalent or at least substantially similar locations or coordinates in each of the different views. For example, a first multiview pixel may have individual sub-pixels corresponding to view pixels located at {x₁, y₁} in each of the different views of a multiview image, while a second multiview pixel may have individual sub-pixels corresponding to view pixels located at {x₂, y₂} in each of the different views, and so on.

In some embodiments, a number of sub-pixels in a multiview pixel may be equal to a number of different views of the multiview display. For example, the multiview pixel may provide sixty-four (64) sub-pixels associated with a multiview display having (64) different views. In another example, the multiview display may provide an eight by four array of views (i.e., 32 views) and the multiview pixel may include thirty-two (32) sub-pixels (i.e., one for each view). Additionally, each different sub-pixel may have an associated direction (e.g., light beam principal angular direction) that corresponds to a different one of the view directions corresponding to the 64 different views, for example. Further, according to some embodiments, a number of multiview pixels of the multiview display may be substantially equal to a number of ‘view’ pixels (i.e., pixels that make up a selected view) in the multiview display views. For example, if a view includes six hundred forty by four hundred eighty view pixels (i.e., a 640×480 view resolution), the multiview display may have three hundred seven thousand two hundred (307,200) multiview pixels. In another example, when the views include one hundred by one hundred pixels, the multiview display may include a total of ten thousand (i.e., 100×100=10,000) multiview pixels.

Herein, a ‘light guide’ is defined as a structure that guides light within the structure using total internal reflection. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore the plate light guide is a planar light guide. In other embodiments, the plate light guide may be curved in one or two orthogonal dimensions. For example, the plate light guide may be curved in a single dimension to form a cylindrical shaped plate light guide. However, any curvature with a radius of curvature sufficiently large to ensure that total internal reflection is maintained within the plate light guide to guide light may be used.

Herein, an ‘angle-preserving scattering feature’ or equivalently an ‘angle-preserving scatterer’ is any feature or scatterer configured to scatter light in a manner that substantially preserves in scattered light an angular spread of light incident on the feature or scatterer. In particular, by definition, an angular spread σₛ of light scattered by an angle-preserving scattering feature is a function of an angular spread σ of the incident light (i.e., σₛ=f(σ)). In some embodiments, the angular spread σₛ of the scattered light is a linear function of the angular spread or collimation factor σ of the incident light (e.g., σₛ=α ·σ, where α is an integer). That is, the angular spread σₛ of light scattered by an angle-preserving scattering feature may be substantially proportional to the angular spread or collimation factor σ of the incident light. For example, the angular spread σₛ of the scattered light may be substantially equal to the incident light angular spread σ (e.g., σₛ≈σ). A uniform diffraction grating (i.e., a diffraction grating having a substantially uniform or constant diffractive feature spacing or grating pitch) is an example of an angle-preserving scattering feature.

Herein, a ‘polarization-preserving scattering feature’ or equivalently a ‘polarization-preserving scatterer’ is any feature or scatterer configured to scatter light in a manner that substantially preserves in scattered light a polarization or at least a degree of polarization of the light incident on the feature or scatterer. Accordingly, a ‘polarization-preserving scattering feature’ is any feature or scatterer where a degree of polarization of a light incident on the feature or scatterer is substantially equal to the degree of polarization of the scattered light. Further, by definition, ‘polarization-preserving scattering’ is scattering (e.g., of guided light) that preserves or substantially preserves a predetermined polarization of the light being scattered. The light being scattered may be polarized light provided by a polarized light source, for example.

Herein, the term ‘unilateral’ as in ‘unilateral scattering element,’ is defined as meaning ‘one-sided’ or ‘preferentially in one direction’ corresponding to a first side as opposed to another direction corresponding to a second side. In particular, a backlight configured to provide or emit light in a ‘unilateral direction’ is defined as a backlight that emits light from a first side and not from a second side opposite the first side. For example, the unilateral direction of emitted light provided by or scattered from a backlight light may correspond to light that is preferentially directed into a first (e.g., positive) half-space, but not into the corresponding second (e.g., negative) half-space. The first half-space may be above the backlight and the second half-space may be below the backlight. As such, the backlight may emit light into a region or toward a direction that is above the backlight and emit little or no light into another region or toward another direction that is below the backlight, for example. Similarly a ‘unilateral’ directional scatterer such as, but not limited to, a unilateral scattering element is configured to scatter light toward and out of a first surface, but not a second surface opposite the first surface, by definition herein.

Herein, a ‘diffraction grating’ is broadly defined as a plurality of features (i.e., diffractive features) arranged to provide diffraction of light incident on the diffraction grating. In some examples, the plurality of features may be arranged in a periodic manner or a quasi-periodic manner. In other examples, the diffraction grating may be a mixed-period diffraction grating that includes a plurality of diffraction gratings, each diffraction grating of the plurality having a different periodic arrangement of features. Further, the diffraction grating may include a plurality of features (e.g., a plurality of grooves or ridges in a material surface) arranged in a one-dimensional (1D) array. Alternatively, the diffraction grating may comprise a two-dimensional (2D) array of features or an array of features that are defined in two dimensions. The diffraction grating may be a 2D array of bumps on or holes in a material surface, for example. In some examples, the diffraction grating may be substantially periodic in a first direction or dimension and substantially aperiodic (e.g., constant, random, etc.) in another direction across or along the diffraction grating. A pitch or spacing between diffractive features may be constant or variable. For example, spacing between features may be greater toward an edge of a light guide and proximal to a light source, and spacing between features may be less toward a central portion of the light guide and distal from the light source.

As such, and by definition herein, a ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating generally has a different propagation direction than a propagation direction of the light incident on the diffraction grating (i.e., incident light). The change in the propagation direction of the light by diffraction is referred to as ‘diffractive redirection’ herein. Hence, the diffraction grating may be understood to be a structure including diffractive features that diffractively redirects light incident on the diffraction grating and, if the light is incident from a light guide, the diffraction grating may also diffractively couple out the light from the light guide.

Further, by definition herein, the features of a diffraction grating are referred to as ‘diffractive features’ and may be one or more of at, in and on a material surface (i.e., a boundary between two materials). The surface may be a surface of a light guide, for example. The diffractive features may include any of a variety of structures that diffract light including, but not limited to, one or more of grooves, ridges, holes and bumps, any of which may be provided at, in or on a material surface. For example, the diffraction grating may include a plurality of substantially parallel grooves in the material surface. In another example, the diffraction grating may include a plurality of parallel ridges rising out of the material surface. The diffractive features (e.g., grooves, ridges, holes, bumps, etc.) may have any of a variety of cross sectional shapes or profiles that provide diffraction including, but not limited to, one or more of a sinusoidal profile, a rectangular profile (e.g., a binary diffraction grating), a triangular profile and a saw tooth profile (e.g., a blazed grating). In other examples, a diffraction grating may be provided inside of, or between surfaces of, a material that comprises a light guide.

According to various examples described herein, a diffraction grating (e.g., a diffraction grating of a diffractive multibeam element, as described below) may be employed to diffractively scatter or couple light out of a light guide (e.g., a plate light guide) as a light beam. In particular, a diffraction angle θₘ of or provided by a locally periodic diffraction grating may be given by equation (1) as:

$${θ}_{m} = {sin}^{- 1} ( n sin {θ}_{i} - \frac{m λ}{d} ) \qquad ( 1 )$$

where λ is a wavelength of the light, m is a diffraction order, n is an index of refraction of a light guide, d is a distance or spacing between features of the diffraction grating, and θᵢ is an angle of incidence of light on the diffraction grating. For simplicity, equation (1) assumes that the diffraction grating is adjacent to a surface of the light guide and a refractive index of a material outside of the light guide is equal to one (i.e., nₒᵤₜ=1). In general, the diffraction order m is given by an integer (i.e., m=+1, 2, . . . ). A diffraction angle θₘ of a light beam produced by the diffraction grating may be given by equation (1). First-order diffraction or more specifically a first-order diffraction angle θₘ is provided when the diffraction order m is equal to one (i.e., m=1).

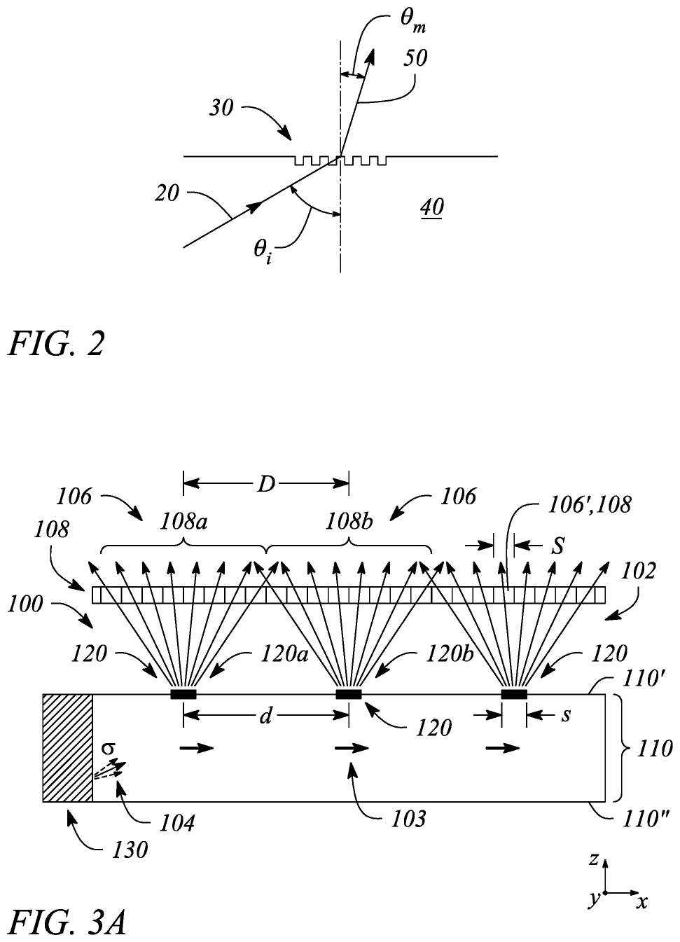

FIG. 2 illustrates a cross sectional view of a diffraction grating 30 in an example, according to an embodiment consistent with the principles described herein. For example, the diffraction grating 30 may be located on a surface of a light guide 40. In addition, FIG. 2 illustrates a light beam 20 incident on the diffraction grating 30 at an incident angle θᵢ. The light beam 20 is a guided light beam within the light guide 40. Also illustrated in FIG. 2 is a coupled-out light beam 50 diffractively produced and coupled-out by the diffraction grating 30 as a result of diffraction of the incident light beam 20. The coupled-out light beam 50 has a diffraction angle θₘ (or ‘principal angular direction’ herein) as given by equation (1). The coupled-out light beam 50 may correspond to a diffraction order ‘m’ of the diffraction grating 30, for example.

Further, the diffractive features may be curved and may also have a predetermined orientation (e.g., a slant or a rotation) relative to a propagation direction of light, according to some embodiments. One or both of the curve of the diffractive features and the orientation of the diffractive features may be configured to control a direction of light coupled-out by the diffraction grating, for example. For example, a principal angular direction of the coupled-out light may be a function of an angle of the diffractive feature at a point at which the light is incident on the diffraction grating relative to a propagation direction of the incident light.

By definition herein, a ‘multibeam element’ is a structure or element of a backlight or a display that produces light that includes a plurality of light beams. A ‘diffractive’ multibeam element is a multibeam element that produces the plurality of light beams by or using diffractive coupling, by definition. A ‘reflective’ multibeam element is a multibeam element that produces the plurality of light beams by or using reflection, by definition. A ‘refractive’ multibeam element is a multibeam element that produces the plurality of light beams by or using refraction, by definition. In an example, a particular multibeam element may comprise one or more of reflective, refractive, and refractive features or elements configured to couple or scatter light out of a light guide.

In some embodiments, a multibeam element may be optically coupled to a light guide of a backlight to provide the plurality of light beams by scattering or coupling out a portion of light guided in the light guide. Further, by definition herein, a multibeam element comprises a plurality of features, or scatterers, within a boundary or extent of the multibeam element. The scatterers may include, but are not limited to, one or more of a diffractive sub-element configured to scatter out guided light using diffractive scattering, a micro-reflective sub-element configured to scatter out guided light using reflective scattering, and a micro-refractive sub-element configured to scatter out guided light using refractive scattering. The light beams of the plurality of light beams (or ‘light beam plurality’) produced by a multibeam element have different principal angular directions from one another, by definition herein. In particular, by definition, a light beam of the light beam plurality has a predetermined principal angular direction that is different from another light beam of the light beam plurality. According to various embodiments, the spacing or grating pitch of the scatterers or features of the diffractive multibeam element may be sub-wavelength (i.e., less than a wavelength of the guided light).

In a particular embodiment, a diffractive multibeam element may be optically coupled to a light guide of a backlight to provide the plurality of light beams by diffractively coupling out a portion of light guided in the light guide. Further, by definition herein, a diffractive multibeam element comprises a plurality of diffraction gratings within a boundary or extent of the multibeam element. According to various embodiments, the spacing or grating pitch of diffractive features in the diffraction gratings of the diffractive multibeam element may be sub-wavelength (i.e., less than a wavelength of the guided light).

According to various embodiments, the light beam plurality may represent a light field. For example, the light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field.

According to various embodiments, the different principal angular directions of the various light beams in the light beam plurality are determined by a characteristic including, but not limited to, a size (e.g., one or more of length, width, area, and etc.) of the multibeam element along with a ‘pitch’ or a feature spacing and an orientation of a feature within a multibeam element. In some embodiments, the multibeam element may be considered an ‘extended point light source,’ i.e., a plurality of point light sources distributed across an extent of the multibeam element, by definition herein. Further, a light beam produced by the multibeam element has a principal angular direction given by angular components {θ, φ}, by definition herein, and as described above with respect to FIG. 1B.

According to various embodiments, guided light or equivalently a guided ‘light beam’ produced by coupling light into the light guide may be a collimated light beam. Herein, a ‘collimated light’ or ‘collimated light beam’ is generally defined as a beam of light in which rays of the light beam are substantially parallel to one another within the light beam. Further, rays of light that diverge or are scattered from the collimated light beam are not considered to be part of the collimated light beam, by definition herein.

Herein, a ‘collimation factor,’ is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined at one-half of a peak intensity of the collimated light beam, according to some examples.

Further herein, a ‘collimator’ is defined as substantially any optical device or apparatus that is configured to collimate light. For example, a collimator may include, but is not limited to, a collimating mirror or reflector, a collimating lens, a diffraction grating, a tapered light guide, and various combinations thereof. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape or similar collimating characteristic in one or both of two orthogonal directions that provides light collimation, according to some embodiments.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein, the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

Further, as used herein, the article ‘a’ is intended to have its ordinary meaning in the patent arts, namely ‘one or more’. For example, ‘an element’ means one or more elements and as such, ‘the element’ means ‘the element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

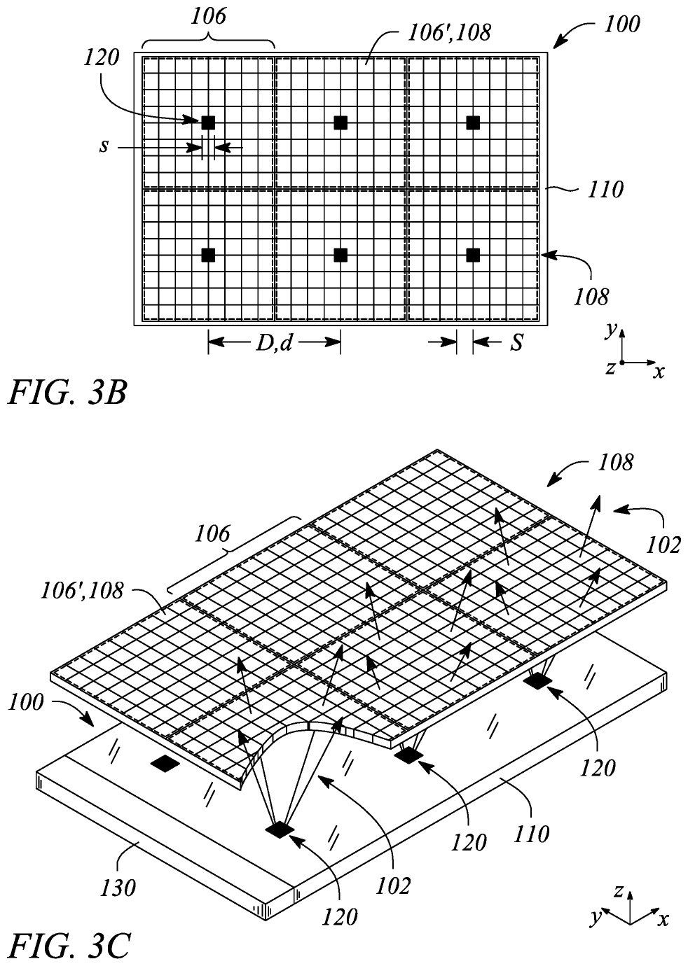

According to some embodiments of the principles described herein, a multiview backlight is provided. FIG. 3A illustrates a cross-sectional view of a multiview backlight 100 in an example, according to an embodiment consistent with the principles described herein. FIG. 3B illustrates a plan view of the multiview backlight 100 in an example, according to an embodiment consistent with the principles described herein. FIG. 3C illustrates a perspective view of the multiview backlight 100 in an example, according to an embodiment consistent with the principles described herein. The perspective view in FIG. 3C is illustrated with a partial cut-away to facilitate discussion herein only.

The multiview backlight 100 illustrated in FIG. 3A, FIG. 3B, and FIG. 3C is configured to provide a plurality of coupled-out light beams 102 having different principal angular directions from one another (e.g., as a light field). In particular, the provided plurality of coupled-out light beams 102 are coupled out and directed away from the multiview backlight 100 in different principal angular directions corresponding to respective view directions of a multiview display, according to various embodiments. In some embodiments, the coupled-out light beams 102 may be modulated (e.g., using light valves, as described below) to facilitate the display of information having three-dimensional (3D) content. FIG. 3A, FIG. 3B, and FIG. 3C also illustrate multiview pixels 106 comprising sub-pixels, such as a sub-pixel 106′ and a light valve array 108, which are described in further detail below.

As illustrated in FIG. 3A, FIG. 3B, and FIG. 3C, the multiview backlight 100 comprises a light guide 110. The light guide 110 is configured to guide light along a length of the light guide 110 as guided light, that is, as a guided light 104. For example, the light guide 110 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 104 according to one or more guided modes of the light guide 110, for example.

In some embodiments, the light guide 110 may be a slab or plate optical waveguide (i.e., a plate light guide) comprising an extended, substantially planar sheet of optically transparent, dielectric material. The substantially planar sheet of dielectric material is configured to guide the guided light 104 using total internal reflection. According to various examples, the optically transparent material of the light guide 110 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 110 may further include a cladding layer (not illustrated) on at least a portion of a surface (e.g., one or both of the top surface and the bottom surface) of the light guide 110. The cladding layer may be used to further facilitate total internal reflection, according to some examples.

Further, according to some embodiments, the light guide 110 is configured to guide the guided light 104 according to total internal reflection at a non-zero propagation angle between a first surface 110′ (e.g., ‘front’ surface or side) and a second surface 110″ (e.g., ‘back’ surface or side) of the light guide 110. In particular, the guided light 104 propagates by reflecting or ‘bouncing’ between the first surface 110′ and the second surface 110″ of the light guide 110 at the non-zero propagation angle. In some embodiments, a plurality of guided light beams (e.g., comprising multiple instances of the guided light 104) comprising different colors of light may be guided by the light guide 110 at respective ones of different color-specific, nonzero propagation angles. Note, the non-zero propagation angle is not illustrated in the figures for simplicity of illustration. However, a bold arrow depicting a first propagation direction 103 illustrates a general propagation direction of the guided light 104 along the length of the light guide 110 in FIG. 3A.

As defined herein, a ‘non-zero propagation angle’ of the guided light 104 is an angle relative to a surface (e.g., the first surface 110′ or the second surface 110″) of the light guide 110. Further, the non-zero propagation angle is both greater than zero and less than a critical angle of total internal reflection within the light guide 110, by definition herein. Moreover, a specific non-zero propagation angle may be chosen (e.g., arbitrarily) for a particular implementation as long as the specific non-zero propagation angle is chosen to be less than the critical angle of total internal reflection within the light guide 110. In various embodiments, the light may be introduced or coupled into the light guide 110 at the non-zero propagation angle of the guided light 104.

In particular, the guided light 104 in the light guide 110 may be introduced or coupled into the light guide 110 at the non-zero propagation angle (e.g., about 30-35 degrees). In some examples, a coupling structure such as, but not limited to, a lens, a mirror or similar reflector (e.g., a tilted collimating reflector), a diffraction grating and a prism (not illustrated) as well as various combinations thereof may facilitate coupling light into an input end of the light guide 110 as the guided light 104 at the non-zero propagation angle. In other examples, light may be introduced directly into a first end or first side or first edge of the light guide 110 either without or substantially without the use of a coupling structure (i.e., direct or ‘butt’ coupling may be employed). Once coupled into the light guide 110, the guided light 104 is configured to propagate along the light guide 110 in the first propagation direction 103 that may be generally away from the first edge (e.g., illustrated by bold arrows pointing along an x-axis in FIG. 3A).

According to various embodiments, the multiview backlight 100 may further comprise one or more light sources, such as including a first light source 130. According to various embodiments, the first light source 130 is configured to provide the light to be guided within light guide 110. In particular, the first light source 130 may be located adjacent to an entrance surface or end (first input end) of the light guide 110. In various embodiments, the first light source 130 may comprise substantially any source of light (e.g., optical emitter) including, but not limited to, a light emitting diode (LED), a laser (e.g., laser diode) or a combination thereof. In some embodiments, the first light source 130 may comprise an optical emitter configured produce a substantially monochromatic light having a narrowband spectrum denoted by a particular color. In particular, the color of the monochromatic light may be a primary color of a particular color space or color model (e.g., a red-green-blue (RGB) color model). In other examples, the first light source 130 may be a substantially broadband light source configured to provide substantially broadband or polychromatic light. For example, the first light source 130 may provide white light. In some embodiments, the first light source 130 may comprise a plurality of different optical emitters configured to provide different colors of light. The different optical emitters may be configured to provide light having different, color-specific, non-zero propagation angles of the guided light corresponding to each of the different colors of light.

In some embodiments, the first light source 130 may further comprise a collimator (not illustrated). The collimator may be configured to receive substantially uncollimated light from one or more of the optical emitters of the first light source 130. The collimator is further configured to convert the substantially uncollimated light into collimated light. In particular, the collimator may provide collimated light having the non-zero propagation angle and being collimated according to a predetermined collimation factor, according to some embodiments. Moreover, when optical emitters of different colors are employed, the collimator may be configured to provide the collimated light having one or both of different, color-specific, non-zero propagation angles and having different color-specific collimation factors. The collimator is further configured to communicate the collimated light beam to the light guide 110 to propagate as the guided light 104, described above.

Accordingly, the guided light 104 produced by coupling light into the light guide 110 may be a collimated light beam, according to various embodiments. Herein, a ‘collimated light’ or a ‘collimated light beam’ is generally defined as a beam of light in which rays of the light beam are substantially parallel to one another within the light beam (e.g., the guided light 104). Further, rays of light that diverge or are scattered from the collimated light beam are not considered to be part of the collimated light beam, by definition herein. In some embodiments, the multiview backlight 100 may include a collimator, such as a lens, reflector or mirror, as described above, (e.g., tilted collimating reflector) to collimate the light, e.g., from a light source, such as from the first light source 130.

As illustrated in FIG. 3A, FIG. 3B, and FIG. 3C, the multiview backlight 100 further comprises a plurality of multibeam elements 120 spaced apart from one another along a length of the light guide 110. In particular, the multibeam elements 120 of the plurality are separated from one another by a finite space and represent individual, distinct elements along the light guide length. That is, by definition herein, the multibeam elements 120 of the plurality are spaced apart from one another according to a finite (i.e., non-zero) inter-element distance (e.g., a finite center-to-center distance). Further, the multibeam elements 120 of the plurality generally do not intersect, overlap or otherwise touch one another, according to some embodiments. That is, each element of the plurality of multibeam elements 120 is generally distinct and separated from others of the multibeam elements 120.

According to some embodiments, the multibeam elements 120 of the plurality may be arranged in either a one-dimensional (1D) array or a two-dimensional (2D) array. For example, the multibeam elements 120 may be arranged as a linear 1D array. In another example, the multibeam elements 120 may be arranged as a rectangular 2D array or as a circular 2D array.

Further, the array (i.e., the 1D or 2D array) may be a regular or uniform array, in some examples. In particular, an inter-element distance (e.g., center-to-center distance or spacing) between the multibeam elements 120 may be substantially uniform or constant across the array. In other examples, the inter-element distance between the multibeam elements 120 may be varied one or both of across the array and along the length of the light guide 110.

According to various embodiments, a multibeam element 120 of the multibeam elements 120 comprises a plurality of scattering sub-elements configured to scatter out, or couple out, a portion of the guided light 104 as the plurality of coupled-out light beams 102. In a particular example, the guided light portion is scattered or coupled out by a plurality of features, such as diffractive features, reflective features, or refractive features. FIG. 3A and FIG. 3C illustrate the coupled-out light beams 102 as a plurality of diverging arrows depicted as being directed away from the first surface 110′ of the light guide 110.

The scattering sub-elements may, according to various embodiments, be arranged in a one-dimensional or two-dimensional array. The sub-elements may be selectively responsive to particular light propagation directions in a light guide. In an example, scattering sub-elements of a particular array (e.g., the one-dimensional array or the two-dimensional array) may be similarly configured to respond to light propagating in a particular direction. Accordingly, a display using the multiple arrays may be configured for full parallax and horizontal-only parallax display modes depending on which (or both) of the arrays is used.

According to various embodiments, a size of the multibeam element of the multibeam elements 120 is comparable to a size of one of the sub-pixels, such as the sub-pixel 106′, in the multiview pixels 106 of a multiview display, as defined above and further described below. Various instances of a multiview pixel are illustrated in FIG. 3A, FIG. 3B, and FIG. 3C with the multiview backlight 100 for the purpose of facilitating discussion. Herein, the ‘size’ may be defined in any of a variety of manners to include, but not be limited to, a length, a width or an area. For example, the size of each of the sub-pixels may be a length thereof and the comparable size of each of multibeam elements 120 may be a length thereof. In another example, the size may refer to an area such that an area of a multibeam element may be comparable to an area of a sub-pixel.

In some embodiments, the size of a particular element of the multibeam elements 120 is comparable to the sub-pixel size such that the multibeam element size is between about twenty-five percent (25%) and about two hundred percent (200%) of the sub-pixel size. For example, if the particular multibeam element size is denoted ‘s’ and the sub-pixel size is denoted ‘S’ (e.g., as illustrated in FIG. 3A), then the diffractive multibeam element size s may be given by equation (2) as

¼S≤s≤2S (2)

In other examples, a particular element size is in a range that is greater than about fifty percent (50%) of the sub-pixel size, or greater than about sixty percent (60%) of the sub-pixel size, or greater than about seventy percent (70%)) of the sub-pixel size, or greater than about eighty percent (80%) of the sub-pixel size, or greater than about ninety percent (90%) of the sub-pixel size, and that is less than about one hundred eighty percent (180%) of the sub-pixel size, or less than about one hundred sixty percent (160%) of the sub-pixel size, or less than about one hundred forty (140%)) of the sub-pixel size, or less than about one hundred twenty percent (120%) of the sub-pixel size. For example, by ‘comparable size’, the multibeam element size may be between about seventy-five percent (75%) and about one hundred fifty (150%) of the sub-pixel size. In another example, the multibeam element may be comparable in size to the sub-pixel 106′ where the diffractive multibeam element size is between about one hundred twenty-five percent (125%) and about eighty-five percent (85%) of the sub-pixel size. According to some embodiments, the comparable sizes of the multibeam element and the sub-pixel 106′ may be chosen to reduce, or in some examples to minimize, dark zones between views of the multiview display. Moreover, the comparable sizes of the multibeam element and the sub-pixel 106′ may be chosen to reduce, and in some examples to minimize, an overlap between views (or view pixels) of the multiview display.

FIG. 3A, FIG. 3B, and FIG. 3C further illustrate the light valve array 108 that is configured to modulate the coupled-out light beams 102 of the coupled-out light beam plurality. The light valve array 108 may be part of a multiview display that employs the multiview backlight 100, for example, and is illustrated in FIGS. 3A-3C along with the multiview backlight 100 for the purpose of facilitating discussion herein. In FIG. 3C, the light valve array 108 is partially cut-away to allow visualization of the light guide 110 and a particular one of the multibeam elements 120 underlying the light valve array 108, for discussion purposes only.

As illustrated in FIGS. 3A-3C, different ones of the coupled-out light beams 102 having different principal angular directions pass through and may be modulated by different ones of the light valves in the light valve array 108. Further, as illustrated, a particular light valve of the array corresponds to a sub-pixel of the multiview pixels 106, and a set of the light valves corresponds to a multiview pixel 106 of the multiview display. In particular, a different set of light valves of the light valve array 108 is configured to receive and modulate the coupled-out light beams 102 from a corresponding one of the multibeam elements 120, i.e., there is one unique set of light valves for each multibeam element of the multibeam elements 120, as illustrated. In various embodiments, different types of light valves may be employed as valves in the light valve array 108 including, but not limited to, one or more of liquid crystal light valves, electrophoretic light valves, and light valves based on electrowetting.

As illustrated in FIG. 3A, a first light valve set 108a is configured to receive and modulate the coupled-out light beams 102 from a first multibeam element 120a. Further, a second light valve set 108b is configured to receive and modulate the coupled-out light beams 102 from a second multibeam element 120b. Thus, each of the light valve sets (e.g., the first and second light valve sets 108a, 108b) in the light valve array 108 corresponds, respectively, both to a different one of the multibeam elements 120 (e.g., elements 120a, 120b) and to a different one of the multiview pixels 106, with individual light valves of the light valve sets corresponding to the sub-pixels of the respective multiview pixel 106.

Note that, as illustrated in FIG. 3A, the size of a sub-pixel, such as the sub-pixel 106′, of the multiview pixels 106 may correspond to a size of a particular light valve in the light valve array 108. In other examples, the sub-pixel size may be defined as a distance (e.g., a center-to-center distance) between adjacent light valves of the light valve array 108. For example, the light valves may be smaller than the center-to-center distance between the light valves in the light valve array 108. The sub-pixel size may be defined as either the size of the light valve or a size corresponding to the center-to-center distance between the light valves, for example.

In some embodiments, a relationship between the multibeam elements 120 and corresponding multiview pixels 106 (i.e., sets of sub-pixels and corresponding sets of light valves) may be a one-to-one relationship. That is, there may be an equal number of multiview pixels 106 and multibeam elements 120. FIG. 3B explicitly illustrates by way of example the one-to-one relationship where each multiview pixel 106 comprising a different set of light valves 108 (and corresponding sub-pixels 106′) is illustrated as surrounded by a dashed line. In other embodiments (not illustrated), the number of multiview pixels 106 and the number multibeam elements 120 may differ from one another.

In some embodiments, an inter-element distance (e.g., center-to-center distance) between a pair of multibeam elements 120 of the plurality may be equal to an inter-pixel distance (e.g., a center-to-center distance) between a corresponding pair of multiview pixels 106, e.g., represented by light valve sets. For example, as illustrated in FIG. 3A, a center-to-center distance d between the first multibeam element 120a and the second multibeam element 120b is substantially equal to a center-to-center distance D between the first light valve set 108a and the second light valve set 108b. In other embodiments (not illustrated), the relative center-to-center distances of pairs of multibeam elements 120 and corresponding light valve sets may differ, e.g., the multibeam elements 120 may have an inter-element spacing (i.e., center-to-center distance d) that is one of greater than or less than a spacing (i.e., center-to-center distance D) between light valve sets representing multiview pixels 106.

In some embodiments, a shape of a multibeam element is analogous to a shape of a multiview pixel or, equivalently, to a shape of a set or ‘sub-array’ of the light valves of the light valve array 108 corresponding to the multiview pixels 106. For example, the first multibeam element 120a may have a square shape and a corresponding one of the multiview pixels 106 (or an arrangement of a corresponding set of light valves of the light valve array 108) may be substantially square. In another example, the first multibeam element 120a may have a rectangular shape, i.e., may have a length or longitudinal dimension that is greater than a width or transverse dimension. In this example, the corresponding one of the multiview pixels 106 (or equivalently the arrangement of the set of light valves of the light valve array 108) corresponding to the first multibeam element 120a may have an analogous rectangular shape. FIG. 3B illustrates a top or plan view of square-shaped multibeam elements 120 and corresponding square-shaped multiview pixels 106 comprising square sets of light valves of the light valve array 108. In yet other examples (not illustrated), the multibeam elements 120 and the corresponding multiview pixels 106 have various shapes including or at least approximated by, but not limited to, a triangular shape, a hexagonal shape, and a circular shape.

Further (e.g., as illustrated in FIG. 3A), each one of the multibeam elements 120 may be configured to provide coupled-out light beams 102 to one and only one of the multiview pixels 106, according to some embodiments. In particular, for a given one of the multibeam elements 120, the coupled-out light beams 102 having different principal angular directions corresponding to the different views of the multiview display are substantially confined to a single corresponding one of the multiview pixels 106 and the sub-pixels thereof, i.e., a single set of light valves of the light valve array 108 corresponding to the first multibeam element 120a, as illustrated in FIG. 3A. As such, each multibeam element of the multibeam elements 120 of the multiview backlight 100 provides a corresponding set of coupled-out light beams 102 that has a set of the different principal angular directions corresponding to the different views of the multiview display (i.e., the set of coupled-out light beams 102 contains a light beam having a direction corresponding to each of the different view directions).

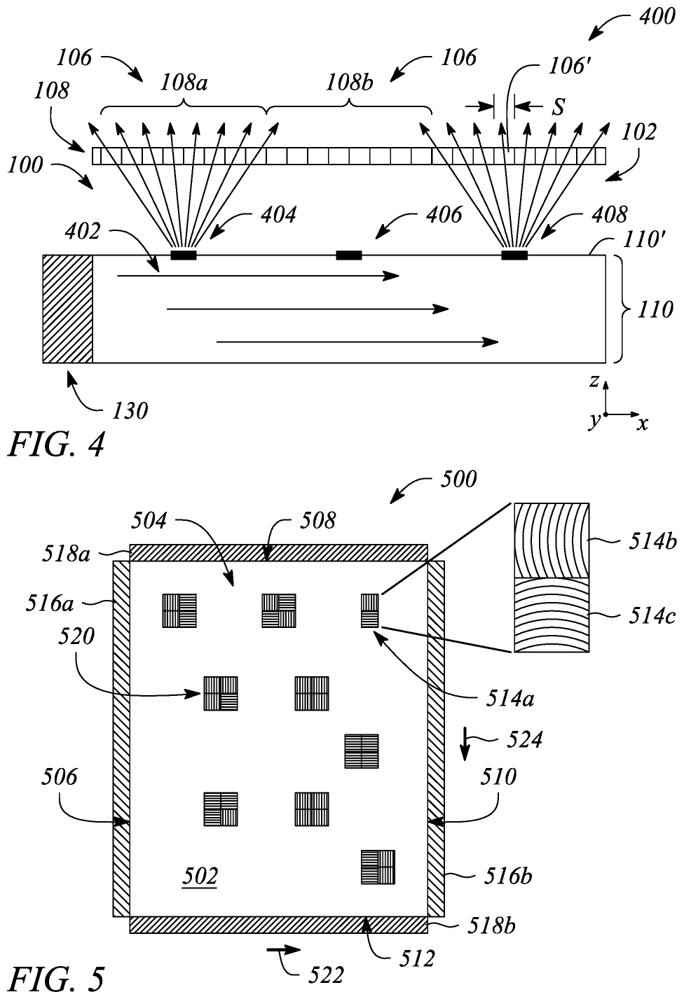

According to some embodiments of the principles described herein, a multiview backlight is provided. FIG. 4 illustrates a cross-sectional view of a backlight 400 in an example, according to an embodiment consistent with the principles described herein. In particular, as illustrated the backlight 400 includes the multiview backlight 100 described above. In FIG. 4 components or features having similar reference numbers may be similar, but not necessarily identical, to those in the example of FIG. 3A.

As illustrated in FIG. 4, collimated light 402 may be received from the first light source 130, such as via a collimator. The collimated light 402 may travel inside the light guide 110 primarily in the x direction. In some embodiments, the collimated light 402 may be redirected or reflected, such as using a reflector or mirror that is positioned on the light guide 110 opposite to the first light source 130.

In FIG. 4 includes a first multibeam element 404, a second multibeam element 406, and a third multibeam element 408. Fewer or additional multibeam elements may optionally be used, however, three are shown for purposes of illustration. In an example, an array (e.g., a two-dimensional array) of multibeam elements may be provided about the light guide 110, as similarly described and illustrated elsewhere herein.

According to various embodiments of the principles described herein, a multibeam element 120 may include one or more scattering sub-elements configured to selectively scatter out a portion of guided light from the light guide 110. The scattered-out portion may correspond to light having a particular direction or orientation inside of the light guide 110. That is, the scattering sub-elements may be configured to preferentially couple out or scatter light that travels in a particular direction inside of the light guide 110 and, at the same time, the same scattering sub-elements may be configured to not couple out or not scatter light that travels in one or more other directions. The scattering sub-elements may include one or more of diffractive features, such as diffraction gratings, reflective features, such as mirrors, or refractive features, such as prisms or material changes. In an example, the scattering sub-elements may be configured to scatter out portions of the light in the light guide 110 using features located on, at, or adjacent to a surface of the light guide 110 or between the light guide surfaces.

The first multibeam element 404 and the third multibeam element 408 may, according to an embodiment, each include one or more scattering sub-elements configured to scatter out the collimated light 402 traveling in the x-direction in the light guide 110. Accordingly, the first multibeam element 404 and the third multibeam element 408 may produce or provide respective light beams 102 using a portion of the light from the light guide 110. The light beams 102 may be modulated by the light valve array 108 to produce a portion of a multiview display, such as described above in the discussion of FIG. 3A.

The second multibeam element 406 illustrated in FIG. 4 may include one or more scattering sub-elements configured to scatter out light that travels in the light guide 110 in other than the x-direction (e.g., they-direction). As illustrated, the third multibeam element 408 may include one or more scattering sub-elements configured to scatter out light that travels in either of the x-direction or the other direction (e.g., the y-direction). Note that since only light traveling in the x-direction is illustrated in FIG. 4, no light is shown as being scattered by the second multibeam element 406. According to some embodiments (not illustrated in FIG. 4), light from multiple different light sources may travel concurrently in the light guide 110 in multiple directions, and therefore light beams may be emitted from the second multibeam element 406 concurrently with the light beams 102 emitted from the first multibeam element 404 and the third multibeam element 408. For example, the light from different light sources on orthogonal sides of the light guide 110 may travel or propagate in each of the x-direction and the y-direction concurrently to enable light beams 102 to be emitted or scattered out simultaneously from each of the first multibeam element 404, the second multibeam element 406, and the third multibeam element 408.

FIG. 5 illustrates a top view of a multiview backlight 500 in an example, according to an embodiment consistent with the principles described herein. As illustrated, the multiview backlight 500 includes a light guide 502 that is configured to guide light as guided light having one or multiple directions within or inside of the light guide. Note that, while the multiview backlight 500 is illustrated in FIG. 5 has a rectangular shape, other shapes may similarly be used.

The multiview backlight 500 of FIG. 5 includes, according to an embodiment, a first light source 516a configured to provide light at a first side 506 of the light guide 502. The light from the first light source 516a may be received by the light guide 502 and transmitted as a portion of the guided light. According to an embodiment, the multiview backlight 500 includes a second light source 518a configured to provide light at a second side 508 of the light guide 502. The light from the second light source 518a may be received by the light guide 502 and transmitted as a different portion of the guided light. As illustrated in FIG. 5, the light from the first light source 516a travels, or is guided, principally or primarily along a first direction 522 or first axis of the light guide 502, and the light from the second light source 518a travels, or is guided, principally or primarily along a second direction 524 of the light guide 502. Further, as illustrated in FIG. 5, the first direction 522 and second direction 524 are orthogonal. Other, non-parallel and non-orthogonal relationships between the light directions may similarly be used, such as when the light guide 502 has a shape other than a rectangle. Although not illustrated in FIG. 5, collimators may optionally be provided, such as between the various light sources and the light guide 502. The guided light may thus be collimated light, according to a collimation factor, in the light guide 502, such as to enhance directionality of the guided light.

In some embodiments, the multiview backlight 500 may include additional light sources to further enhance brightness. For example, the multiview backlight 500 as illustrated in FIG. 5 further includes a third light source 516b and a fourth light source 518b. The third light source 516b is provided at a third side 510 of the light guide 502 that is opposite to the first side 506, and the fourth light source 518b is provided at a fourth side 512 of the light guide 502 that is opposite to the second side 508. Light from the third light source 516b may be provided in the light guide 502 in a direction that is parallel to the first direction 522, and light from the fourth light source 518b may be provided in the light guide 502 in a direction that is parallel to the second direction 524. Using light from oppositely-oriented pairs of sources may increase an amount or density of light available in the light guide 502 for scattering or out-coupling, such as using one or more multibeam elements that are in or on the light guide 502.

FIG. 5 illustrates a two-dimensional (2D) multibeam element array 504 in an example, according to an embodiment consistent with the principles described herein. The multibeam element array 504 includes a first multibeam element 514a, a second multibeam element 520, and other multibeam elements that are disposed in or on the light guide 502. In an example, the multibeam element array 504 may include as few as two multibeam elements. Generally, however, the number of multibeam elements in the multibeam element array 504 may be determined based on a pixel size and a size of the light guide 502. The multibeam elements of the multibeam element array 504 may be distributed about the light guide 502, such as evenly or at a fixed pitch or spacing, or distances between different elements of the array may be varied. The multiview backlight 500 of FIG. 5 illustrates nine multibeam elements in the multibeam element array 504, however, fewer or additional elements may be used.

FIG. 5 illustrates a first multibeam element 514a of the multibeam element array 504, according to an embodiment consistent with the principles described herein. The first multibeam element 514a may include a plurality of scattering sub-elements, including a first scattering sub-element 514b and a second scattering sub-element 514c. The first and second scattering sub-elements 514b, 514c may be configured to collectively scatter out portions of the guided light in the light guide 502 as directional light beams corresponding to different view directions of a multiview display, such as of the multiview display 10.

According to an embodiment, the first scattering sub-element 514b of the first multibeam element 514a may be configured to selectively scatter out at least a first portion of the guided light from the light guide 502. In an example, the first portion of the guided light may include light that travels in, or is parallel to, the first direction 522. That is, the first scattering sub-element 514b may be configured to selectively scatter out light from the light guide 502 that was received from at least one of the first light source 516a and the third light source 516b. In an example, the first scattering sub-element 514b preferentially scatters out light traveling in the first direction 522 and the first scattering sub-element 514b is substantially transparent or non-responsive to light traveling in other directions in the light guide 502. Similarly, the second scattering sub-element 514c may be configured to selectively scatter out at least a second portion of the guided light from the light guide 502. The second portion of the guided light may include light that travels in, or is parallel to, to the second direction 524. The second scattering sub-element 514c may be substantially transparent or non-responsive to light traveling in directions other than the second direction 524. In particular, the second scattering sub-element 514c may be substantially non-responsive to light traveling in, or parallel to, the first direction 522.

According to some embodiments, the scattering sub-elements of a multibeam element may be directionally responsive or directionally selective and may also be color responsive. For example, the first scattering sub-element 514b may be configured to be preferentially responsive to first light of a particular first color propagating in the first direction 522 and may be configured to be substantially transparent to other light having other than the first color, including when the other light also propagates in the first direction 522. In other embodiments, scattering is directionally responsive or directionally selective, while not being color responsive.

According to an embodiment consistent with the principles described herein, instances of scattering sub-elements may be grouped together to form a particular multibeam element of the multibeam element array 504. The instances of the scattering sub-elements may be similarly or differently configured. For example, a first multibeam element may include a single instance of a scattering sub-element that is preferentially responsive to light traveling in a particular direction, and a second multibeam element may include multiple instances of scattering sub-elements that are preferentially responsive to light traveling in the same particular direction. In another example, a third multibeam element may include at least two instances of differently configured scattering sub-elements such that the different instances are configured to respond to light traveling in respective different directions.

In FIG. 5, the first multibeam element 514a comprises a pair of scattering sub-elements that are differently configured. That is, the pair of scattering sub-elements are configured to selectively scatter out or respond to light traveling in respective different directions. The multiview backlight 500 of FIG. 5 includes the second multibeam element 520 that includes four instances of scattering sub-elements, three of which are similarly configured to respond to light traveling in a first direction, while a fourth is configured to respond to light traveling in a second direction that is different from the first direction. The groupings of different types of scattering sub-elements may be selected to vary or change a density of the different types of sub-elements about the light guide 502. For example, it may be desirable to provide more instances of a particular scattering sub-element that are responsive to first light at locations that are further from a light source of the first light. In this way, a behavior or uniformity of light provided by a backlight may be specified by a designer.

Scattering sub-elements that comprise a particular multibeam element may have similar or different features that are configured to scatter light from the light guide 502. For example, the scattering sub-elements may include one or more of a diffractive sub-element configured to scatter out guided light using diffractive scattering, a micro-reflective sub-element configured to scatter out guided light using reflective scattering, and a micro-refractive sub-element configured to scatter out guided light using refractive scattering. The various scattering sub-elements may be provided in, on, or otherwise coupled to the light guide 502. According to various embodiments, the scattering sub-elements may be disposed between, and spaced apart from, surfaces (e.g., sides, edges, light-emitting or emission surfaces, light-receiving surfaces, etc.) of the light guide 502. In an example, the scattering sub-elements may be co-located in that they may be co-planar and/or adjacent, such as with or without intervening inter-element spaces or other intervening features. In an example, two or more scattering sub-elements may be stacked (e.g., in a direction that is orthogonal to the first direction 522 and the second direction 524) or overlaid.

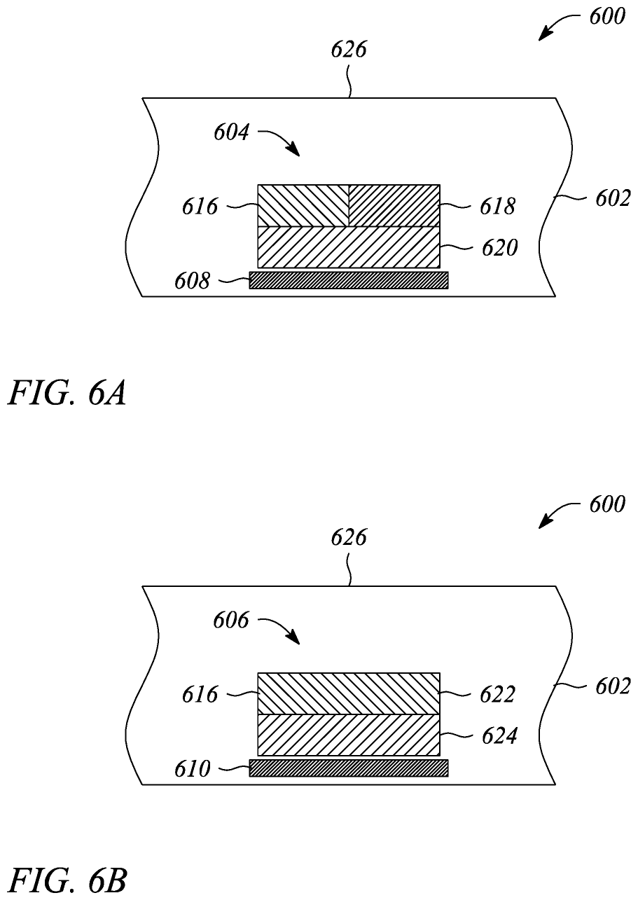

According to some embodiments of the principles described herein, a multiview backlight is provided with stacked scattering sub-elements that comprise a multibeam element. FIG. 6A illustrates a cross-sectional view of a portion of a backlight 600 in an example, according to an embodiment consistent with the principles described herein. FIG. 6B illustrates a cross-sectional view of a portion of a backlight 600 in an example, according to another embodiment consistent with the principles described herein. The backlight 600 illustrated in FIGS. 6A-6B may include a plurality of multibeam elements, such as may be provided in a multibeam element array, within a light guide 602. The light guide 602 may be configured to guide light in multiple propagation directions. Further, multibeam elements of the multibeam element array may include one or both of a first stacked multibeam element 604 as illustrated in FIG. 6A and a second stacked multibeam element 606 as illustrated in FIG. 6B. Note that the first and second stacked multibeam elements 604, 606 are illustrated separately in FIGS. 6A and 6B for ease of illustration and not by way of limitation.

According to an example embodiment, the first stacked multibeam element 604 and the second stacked multibeam element 606 may each include respective different instances of scattering sub-elements, and each scattering sub-element may be configured to selectively scatter out a portion of the guided light from the light guide 602. As similarly discussed above, the different scattering sub-elements may be configured to respond primarily or exclusively to light traveling in a particular direction in the light guide 602.

As illustrated in FIG. 6A, the first stacked multibeam element 604 may include a first scattering sub-element 616, a second scattering sub-element 618, and a third scattering sub-element 620. The different scattering sub-elements may be similarly or differently configured such that they respond to light propagating in the same or different directions in the light guide 602. For example, the first scattering sub-element 616 may be configured to respond to light propagating substantially in a first direction in the light guide 602, while the second scattering sub-element 618 and the third scattering sub-element 620 may be configured to respond to light propagating substantially in a different second direction in the light guide 602. The first and second directions of traveling light may be orthogonal or may have another non-parallel relationship.

As illustrated in FIG. 6B, the second stacked multibeam element 606 may include a first scattering sub-element 622 and a second scattering sub-element 624. The first scattering sub-element 622 and the second scattering sub-element 624 may be configured to scatter light propagating in respective different directions in the light guide 602.

In an example, one or more reflectors may be provided to help further guide and enhance light output from the scattering sub-elements. For example, a reflector 608 may be provided substantially adjacent or near to the first stacked multibeam element 604. The reflector 608 may be configured to direct light toward a light-emission surface 626 of the light guide 602, such as via or through the first stacked multibeam element 604. Similarly, a reflector 610 may be provided substantially adjacent or near to the second stacked multibeam element 606 and may be configured direct light toward the light-emission surface 626 via or through the second stacked multibeam element 606. The reflector 608 and the reflector 610 may be reflective islands that are configured to reflect light scattered by the respective multibeam elements toward the light-emission surface 626. That is, portions of light that is scattered by the first stacked multibeam element 604, the second stacked multibeam element 606 in a direction that is away from the light-emission surface 626 may be respectively received by the reflectors 608, 610 and then reflected toward the light-emission surface 626.

In accordance with some embodiments (not illustrated), one or more of the scattering sub-elements of a multibeam element may comprise a reflective material such as a metal grating. For example, a bottommost scattering sub-element in a stacked multibeam element may comprise a reflective metal material and may be configured to function as a scattering sub-element and as a reflector to other light, such as other light that may be received from other scattering sub-elements in the same stacked multibeam element.

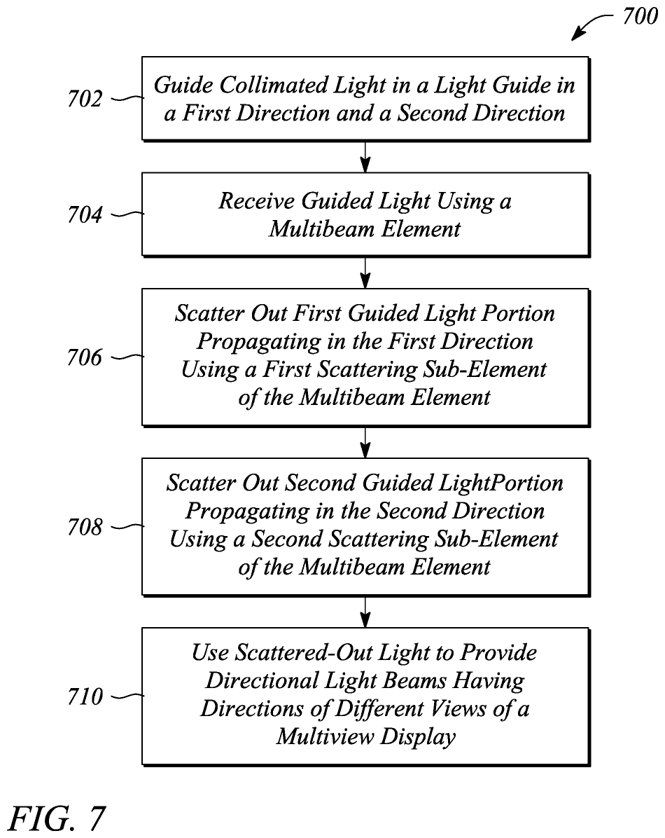

In accordance with other embodiments of the principles described herein, a method of multiview backlight operation is provided. FIG. 7 illustrates a flow chart of a method 700 of multiview backlight operation in an example, according to an embodiment consistent with the principles described herein. As illustrated in FIG. 7, the method 700 of multiview backlight operation comprises guiding 702 collimated light in a light guide. In some embodiments, the light may be guided at a non-zero propagation angle. Further, the guided light may be collimated, e.g., collimated according to a predetermined collimation factor. According to some embodiments, the light guide may be substantially similar to one or more of the light guide 110, the light guide 502, or the light guide 602, such as described above. Guiding 702 the collimated light may include guiding light in multiple different directions in the light guide, such as at least in a first direction and a second direction that are non-parallel and different from one another.

As illustrated in FIG. 7, the method 700 of multiview backlight operation further comprises receiving 704 guided light using a multibeam element of a multibeam element array. For example, receiving 704 the guided light may include using a particular multibeam element of the multibeam element array 504. The particular multibeam element may include one or more scattering sub-elements configured to scatter out a portion of the guided light from the light guide to provide a plurality of scattered or coupled-out light beams having multiple different principal angular directions. In various embodiments, the principal angular directions of the coupled-out light beams correspond to respective view directions of a multiview display. According to various embodiments, a size of the particular multibeam element is comparable to a size of a sub-pixel in a multiview pixel of the multiview display. For example, the particular multibeam element may be greater than one quarter of the sub-pixel size and less than twice the sub-pixel size.

In some embodiments, the method 700 further comprises scattering out 706 a first portion of the guided light from the light guide using a first scattering sub-element of the multibeam element. Scattering out 706 the first portion may include scattering out a portion of the guided light propagating in the first direction in the light guide. Further, scattering out 706 the first portion may be provided without substantial scattering out of light that propagates in the light guide in directions other than the first direction, according to various embodiments. Scattering out 706 the first portion may include using a first scattering sub-element of the particular multibeam element that received 704 the guided light.

The method 700 further comprises scattering out 708 a second portion of the guided light from the light guide. Scattering out 708 the second portion may include scattering out a portion of the guided light propagating in the second direction in the light guide. Further, scattering out 708 the second portion may be provided without substantial scattering out of light that propagates in the light guide in other directions, according to various embodiments. Scattering out 708 the second portion may include using a second scattering sub-element of the same particular multibeam element that received 704 the guided light. That is, scattering out 706 the first portion and scattering out 708 the second portion may include using different scattering sub-elements of the same multibeam element, and the different scattering sub-elements may be differently configured such that they respond to, or scatter, light that propagates in different directions (e.g., first and second directions) in the light guide.

In some embodiments, the method 700 further comprises using 710 the scattered-out light from the light guide to provide a plurality of directional light beams having directions that correspond to different view directions of the multiview display. Providing the plurality of directional light beams using 710 the scattered-out light may include modulating the light beams from the particular multibeam element using light valves configured as multiview pixels of the multiview display. According to some embodiments, the light valves may be substantially similar to the light valve array 108 described herein. In particular, different sets of light valves may correspond to different multiview pixels in a manner similar to the correspondence of the first and second light valve sets 108a, 108b to different multiview pixels 106. Further, individual light valves may correspond to sub-pixels of the multiview pixels as the light valve array 108 corresponds to the sub-pixel 106′.

Thus, there have been described examples and embodiments of a multiview backlight, an array of multibeam elements respectively comprising scattering sub-elements, methods of multiview backlight operation, and a multiview display that employs multibeam elements to provide light beams corresponding to plurality of different views of a multiview image. A multibeam element comprises a plurality of scattering sub-elements, and the multibeam element is comparable in size to a sub-pixel of a multiview pixel of the multiview display. It should be understood that the above-described examples are merely illustrative of some of the many specific examples that represent the principles described herein. Clearly, those skilled in the art may readily devise numerous other arrangements without departing from the scope as defined by the following claims.

What is claimed is:

1. A multiview backlight comprising:
a light guide configured to guide light as guided light having both a first direction and a second direction within the light guide, the first and second directions being different from one another; and
a multibeam element array including a plurality of spaced apart multibeam elements, wherein a multibeam element of the multibeam element array comprises a plurality of scattering sub-elements configured to scatter out portions of the guided light as directional light beams corresponding to different view directions of a multiview display,
wherein a first scattering sub-element of the plurality of scattering sub-elements is configured to selectively scatter out at least a portion of the guided light having the first direction and a second scattering sub-element of the plurality of scattering sub-elements is configured to selectively scatter out at least a portion of the guided light having the second direction.

2. The multiview backlight of claim 1, wherein a size of a multibeam element of the multibeam element array is between twenty-five and two hundred percent of a size of a light valve in an array of light valves of the multiview display.

3. The multiview backlight of claim 1, wherein the guided light having one or both of the first direction and the second direction is collimated according to a collimation factor, and wherein the first direction of the guided light is orthogonal to the second direction of the guided light.

4. The multiview backlight of claim 1, wherein a scattering sub-element of the plurality of scattering sub-elements comprises one or more of a diffractive sub-element configured to scatter out guided light using diffractive scattering, a micro-reflective sub-element configured to scatter out guided light using reflective scattering, and a micro-refractive sub-element configured to scatter out guided light using refractive scattering.

5. The multiview backlight of claim 1, wherein the multibeam element comprises a reflective island comprising a reflector configured to reflect light scattered by the multibeam element toward an emission surface of the light guide.

6. The multiview backlight of claim 1, further comprising a reflector configured to reflect light from the multibeam element toward an emission surface of the light guide.

7. The multiview backlight of claim 1, wherein the multibeam element array includes a plurality of reflectors respectively corresponding to multibeam elements of the multibeam element array, wherein the reflectors are configured to reflect light toward an emission surface of the light guide.

8. The multiview backlight of claim 1, wherein multibeam elements of the multibeam element array are arranged in a two-dimensional (2D) array.

9. The multiview backlight of claim 1, wherein either the first and second scattering sub-elements are co-planar and adjacent to each other in the multibeam element or the first scattering sub-element and the second scattering sub-element are stacked within the multibeam element.

10. The multiview backlight of claim 1, wherein the multibeam element is either disposed adjacent to a surface of the light guide or disposed between, and spaced apart from, surfaces of the light guide.

11. The multiview backlight of claim 1, further comprising:
a first light source configured to provide light at a first side of the light guide, the light provided by the first light source at the first side being the guided light having the first direction; and
a second light source configured to provide light at a second side of the light guide, the light provided by the second light source at the second side being the guided light having the second direction, wherein the first side and the second side of the light guide are non-parallel.

12. A multiview display comprising the multiview backlight of claim 1, the multiview display further comprising an array of light valves configured to modulate the directional light beams to provide a multiview image having different views corresponding to different view directions of the multiview display.

13. The multiview display of claim 12, wherein light valves of the light valve array comprise a plurality of multiview pixels, and each multibeam element of the multibeam element array is configured to provide the directional light beams to a different multiview pixel of the plurality of multiview pixels.

14. A multiview display comprising:
a light guide configured to guide light in a first propagation direction and a second propagation direction as guided light within the light guide, the first propagation direction being different from the second propagation direction;
a multibeam element array configured to scatter out portions of the guided light as directional light beams having directions corresponding to different view directions of the multiview display; and
a light valve array configured to modulate the directional light beams to provide a multiview image having different views in the different view directions,
wherein a multibeam element of the multibeam element array comprises a first scattering sub-element configured to selectively scatter out a portion of the guided light having the first propagation direction and a second scattering sub-element configured to selectively scatter out a portion of the guided light having the second propagation direction.

15. The multiview display of claim 14, wherein one or both of the guided light having the first propagation direction and the guided light having the second propagation direction is collimated according to a collimation factor.

16. The multiview display of claim 14, wherein at least one of the first and second scattering sub-elements is one or more of configured to scatter out a portion of the guided light using directionally selective diffractive scattering, configured to scatter out a portion of the guided light using directionally selective reflective scattering, and configured to scatter out a portion of the guided light using directionally selective refractive scattering.

17. The multiview display of claim 14, wherein either the first scattering sub-element and the second scattering sub-element are stacked upon each other in the multibeam element or the first scattering sub-element and the second scattering sub-element are co-planar and adjacent in the multibeam element.

18. A method of multiview backlight operation, the method comprising:
guiding light in a light guide to propagate as guided light in both of a first direction and a second direction within the light guide, the first and second directions being different from one another; and
scattering out portions of the guided light using an array of multibeam elements to provide a plurality of directional light beams having directions corresponding to different view directions of a multiview display,
wherein a multibeam element of the array of multibeam elements comprises a first scattering sub-element that preferentially scatters out the guided light propagating in the first direction and a second scattering sub-element that preferentially scatters out the guided light propagating in the second direction.

19. The method of multiview backlight operation of claim 18, wherein guiding light in the light guide comprises guiding collimated guided light that is collimated according to a collimation factor, and
wherein scattering out portions of the guided light comprises one or more of:
diffractively scattering using a multibeam element of the multibeam element array, one or both of the first and second scattering sub-elements being a diffraction grating scattering element;
reflectively scattering using a multibeam element of the multibeam element array, one or both of the first and second scattering sub-elements being a micro-reflective scattering element; and
refractively scattering using a multibeam element of the multibeam element array, one or both of the first and second scattering sub-elements being a micro-refractive scattering element.

20. The method of multiview backlight operation of claim 18, wherein the first scattering sub-element and the second scattering sub-element are stacked upon each other in the multibeam element.
